(19) United States
(12) Patent Application Publication
(10) Pub. No.: US 2012/0035309 A1
(43) Pub. Date: Feb. 9, 2012

(54) METHOD TO DISPERSE NANOPARTICLES INTO ELASTOMER AND ARTICLES PRODUCED THEREFROM

(75) Inventors: Jiang Zhu, Missouri City, TX (US); Lillian Guo, Houston, TX (US)

(73) Assignee: BAKER HUGHES INCORPORATED, Houston, TX (US)

(21) Appl. No.: 12/851,701

(22) Filed: Aug. 6, 2010

(51) Int. Cl. C08K 5/12; C08K 5/11

(52) U.S. Cl. 524/296; 524/314; 977/750; 977/752; 977/773

(57) ABSTRACT

Methods of making elastomeric nanocomposites with improved nanoparticle dispersion in the elastomer are described. The method includes the use of liquid form additives such as oils, plasticizers and/or solvents as dispersing agents to disperse nanoparticles into elastomers. Also described are articles such as downhole elements including the elastomeric nanocomposites made by the methods described herein.

### FIELD OF THE DISCLOSURE

The present disclosure relates to elastomeric compositions, in particular methods of making elastomeric nanocomposites.

### BACKGROUND

A nanocomposite is a multiphase solid material where one of the phases has one, two or three dimensions of less than 100 nanometers (nm), such as carbon nanotubes dispersed in a polymeric matrix. Compared to the polymeric matrix alone, nanocomposites can exhibit improved properties such as mechanical properties, e.g., strength and/or stability, electrical conductivity, decreased permeability to gas and liquids, thermal stability, and chemical resistance. Nanocomposites have found utility in a variety of applications such as electronics, automotive applications and biomaterials.

Nanocomposites such as polymer-carbon nanotube composites can be used in downhole applications such as downhole tools, carbon dioxide sequestration applications, etc. The environmental conditions in deep oil wells, for example, such as underground or undersea wells, are very harsh, with temperatures of 250° C. or more and pressures in excess of 20,000 psi. Further, the downhole environment contains various small molecule gases and liquids, which can penetrate or permeate through polymers or seals, particularly at high temperature and pressure. Many of the tools, tubulars, valves, and the like, used during subsurface drilling, exploration and/or oil production include housings, sleeves, or seals to protect the inside components or to prevent fluid leakages. Polymeric nanocomposites are materials that can both survive under these extreme conditions and provide effective barriers to fluid permeation or penetration under high temperatures and pressures.

One problem in the production of polymeric nanocomposites is that nanoparticles such as carbon nanotubes generally disperse poorly and tend to aggregate as buddle/rope form. Techniques such as physical mixing even high shear mixing are generally unable to produce good dispersion of nanoparticles in elastomers. The methods disclosed herein address this and other deficiencies in the art.

### SUMMARY

In one embodiment, a method of making a nanocomposite includes dispersing nanoparticles in a liquid form additive to provide a nanoparticle pre-blend, and blending the nanoparticle pre-blend with an elastomer to form the nanocomposite.

In another embodiment, a method of making a downhole element includes dispersing a nanoparticle in a liquid form additive to provide a nanoparticle pre-blend, blending the nanoparticle pre-blend with an elastomer to form the nanocomposite, and molding the elastomer into the downhole element.

In yet another embodiment, a downhole element includes a homogeneous nanocomposite, wherein the homogeneous nanocomposite is formed by dispersing a nanoparticle in a liquid form additive to provide a nanoparticle pre-blend, and blending the nanoparticle pre-blend with an elastomer to form the homogeneous nanocomposite.

### DETAILED DESCRIPTION

Described herein are methods of producing elastomeric nanocomposites and articles containing these nanocomposites. More particularly, disclosed herein is the use of liquid form additives such as oils, plasticizers and/or solvents as dispersing agents to disperse nanoparticles into elastomers. The disclosed methods advantageously produce elastomeric nanocomposites with improved dispersion of the nanoparticles in the elastomer compared to prior methods such as directly mixing nanoparticles into elastomer base materials.

In one embodiment, a method of making a nanocomposite comprises dispersing a nanoparticle in a liquid form additive to provide a nanoparticle pre-blend and blending the nanoparticle pre-blend with an elastomer to form the nanocomposite. In one embodiment, the nanoparticle pre-blend and the elastomer are blended to form a homogeneous nanocomposite, that is, a nanocomposite of uniform composition throughout.

As used herein, a liquid form additive for an elastomer is an additive that is a liquid at room temperature or under standard processing conditions. Exemplary liquid form additives include oils, other plasticizers and/or solvents.

Exemplary oils for use in the nanoparticle pre-blend are oils that serve as plasticizers, softeners, and processing aids during elastomer processing. Nonlimiting examples of oils include synthetic and natural mineral oils, naphthenic oils, paraffinic oils or mineral oil, olefin oligomers and low molecular weight polymers, vegetable oils, animal oils, hydrogenated oils, and combinations thereof. Specific oils include Shellflex® paraffinic oil and the Cyclolube® series of naphthenic hydrocarbon oils.

In addition to oils, other plasticizers that are available in liquid form are used in elastomeric compositions and can be used to disperse nanoparticles. Exemplary plasticizers include polyester glutarate, trioctyl trimellitate, di(2-ethylhexyl) phthalate; di(butoxy-ethoxy-ethyl) adipate, dibutyl phthalate (DBP), and the like, and combinations thereof.

Exemplary solvents for use in the nanoparticle pre-blend are solvents that are compatible with both the elastomer, and the oil and elastomer when an oil is present. Nonlimiting examples of solvents include organic solvents and/or solvent mixtures in which the elastomer is homogeneously dissolved at greater than 90 wt % under the processing conditions. Specific solvents include aromatic and/or chlorinated solvents, as well as ketones and cyclic ethers, including, acetone, hexane, ethyl ether, toluene, benzene, chlorobenzene, chloroform, methylene chloride, methyl ethyl ketone, dimethylformamide, tetrahydrofuran, and mixtures thereof.

Nanoparticles include single, double, multi-walled nanotubes and nano fibers, nanorods, nanoions, nanocoils, nanofibers, nanoribbons, nanoclay, graphite nanoplatelets, nanoflakes, expanded graphite nanoflakes, expanded nanoplatelets, graphite oxide, thermally exfoliated graphite oxide, single and multiple layer graphene sheets, graphene oxide; metal oxide nanoparticles, polyhedral oligomeric silsesquioxanes (POSS), nanoparticle minerals (such as silica, alumina, mica, graphite, carbon black, fumed carbon, and fly ash), their functionalized derivatives, and combinations thereof. Expanded graphite nanoflakes or nanoplatelets have had their layers separated by one or more thermal, chemical, and/or or physical methods. Nanoflakes generally mean flake-like graphite sheets that can be formed into a patchwork-like structure. Nanoplatelets generally have “platelet” morphology, meaning they have a very thin but wide aspect. Metal oxide nanoparticles include oxides of zinc, iron, titanium, magnesium, silicon, aluminum, cerium, zirconium, as well as mixed metal compounds such as indium-tin and the like.

Functionalization of nanoparticles is advantageous to facilitate dispersion in a polymer by chemically covalently bonding or physically wrapping functional groups onto the nanoparticle surface, for example. Organic functional groups can provide a high binding affinity and selectivity through formation of either hydrogen or covalent bonds. Through functionalization, carbon nanotube or graphene can exhibit improved solubility in common organic solvents, as well as improved material properties and processability of composites. Carbon nanotubes, for example, can be “end-functionalized” with bonds on edges and open tube ends or “sidewall functionized” with bonds made to the wall that keep the carbon-carbon bonds of the wall intact.

Functionalities can be unsaturated such as allyl, vinyl, free radical, fluorine, carboxyl, epoxy, amine, hydroxyl, long chain hydrocarbon and the like, and combinations thereof. Carboxylic acid functionalization can be achieved by treatment with an oxidant. Methods to functionalize SWNT sidewalls with organic groups include fluorination followed by subsequent reactions with reactions with alkyl lithium and metal alkoxides, as well as by Grignard reagents or diamines, with aryl diazonium salts, azomethine ylides, carbenes, nitrenes, and organic radicals. Functional groups should be compatible with oil and elastomer base materials. Particular examples include long chain hydrocarbons, surfactant molecules with lipophilic ends that dissolve in oils, lipids, and non-polar solvents such as hexane or toluene. Particular functionalization methods include commonly used strong acid treatment in acids such as concentrated nitric acid, sulfuric acid, oleum and their mixture with strong oxidizing agent such as potassium chlorate, potassium permanganate, and the like, followed by further chemical reaction, wherein the functional groups are attaching to nanoparticle by reaction with carboxylic group or free radical polymerization etc. Another exemplary functionalization method includes fluorination treatment followed by replacement of fluorine with other functional groups.

Exemplary methods for forming the pre-blends are methods that disaggregate, deglomerate, disentangle and/or disperse nanoparticles such as milling, high power probe sonication, and high shear homogenization. In one embodiment, the pre-blend is a uniform dispersion of nanoparticles in the solvent and/or oil.

In one embodiment, an oil/solvent mixture is used to form the pre-blend. In this embodiment, the solvent is optionally removed from the pre-blend prior to blending with the elastomer by a method such as evaporation.

The pre-blend is then blended with the elastomer to form the nanocomposite by a suitable method for homogeneous blending such as roll milling, shear mixing, extrusion, and the like. In one embodiment, the elastomer is dissolved in a second solvent prior to adding the pre-blend and the nanocomposite is formed using, for example, a coagulation method. The solvent used in the pre-blend and the second solvent used to dissolve the elastomer can be the same or different. Solvent is optionally completely removed by evaporation after mixing.

The total nanoparticle concentration in the nanocomposite is about 0.01 wt % to about 20 wt %, specifically about 0.1 wt % to about 5 wt %.

“Elastomer” as used herein is a term for substances emulating natural rubber in that they stretch under tension, have a high tensile strength, retract rapidly, and substantially recover their original dimensions. The term includes natural and man-made elastomers, such as a thermoplastic elastomer or a non-thermoplastic elastomer. The term includes blends (physical mixtures) of elastomers, as well as copolymers, terpolymers, and multi-polymers. Examples include ethylene-propylene-diene monomer (EPDM) rubber, nitrile rubber, nitrile butadiene rubber (NBR) which is a copolymer of acrylonitrile and butadiene, carboxylated acrylonitrile butadiene rubber (XNBR), hydrogenated acrylonitrile butadiene rubber (HNBR) which is commonly referred to as highly saturated nitrile (HSN), carboxylated hydrogenated acrylonitrile butadiene rubber (XHNBR), hydrogenated carboxylated acrylonitrile butadiene rubber (HXNBR), ethylene propylene rubber (EPR), tetrafluoroethylene and propylene monomer (FEPM) elastomers, fluoroelastomers (FKM), perfluoroelastomer (FEKM), or a combination thereof. In one embodiment, the elastomer is a commercially available elastomer such as Alfas®, an alternating copolymer of tetrafluoroethylene and propylene (“TFE/P”), and Kalrez ®and Chemraz®, both perfluroelastomers.

Relatively non-elastic polymeric materials (relative to elastomers), such as thermoplastic and thermoset polymeric materials, may be combined or mixed with the elastomers, at a weight of from about 1 to 40 phr of the elastomer composition. Relatively non-elastic polymeric materials include natural and synthetic polymers, blends of natural and synthetic polymers, and layered versions of polymers, wherein individual layers may be the same or different in composition and thickness. In one embodiment, the non-elastic polymer comprises one or more thermoplastic polymers and/or one or more thermoset and/or thermally cured polymers, and combinations thereof.

A thermoplastic material is a polymeric material that softens and melts when exposed to elevated temperatures and generally returns to its original condition, i.e., its original physical state, when cooled to ambient temperatures. Thermoplastic materials (including thermoplastic elastomers) can be molded into various shapes and sizes. Examples of thermoplastic materials include polyolefins, polyamides, polyesters, thermoplastic polyurethanes and polyurea urethanes, PP, PE, PP-PE copolymer, PVC and other polyolefins, polyamides, polyetheretherketones (PEEK), polyaryletherketones (PAEK), polyetherimides (PEL), copolymers of tetrafluoroethylene and perfluorovinylether (PFA), perfluoroalkoxy copolymers (MFA), polycarbonates, polyetherimides, polyesters, polysulfones, polystyrenes, acrylonitrile-butadiene-styrene block copolymers, acetal polymers, polyaxnides, copolymers, blends, and combinations thereof.

Exemplary thermoset (thermally cured) polymers for use in elastomeric nanocomposites include phenolic resins, epoxy resins, phenoxy, phenolic, ester, polyurethane, polyurea, and combinations thereof.

Other useful materials or components that may be added to the elastomeric nanocomposites include, but are not limited to, fillers, coupling agents, oils, antistatic agents, flame retardants, heat stabilizers, ultraviolet stabilizers, internal lubricants, antioxidants, and processing aids. One such additive is an inorganic swelling agent, which functions to enhance the water-swellability of the elastomeric compositions. Swelling agents include alkali- and alkaline earth carbonates, such as, but not limited to, carbonates of sodium (sodium carbonate; soda ash). The amounts of such additives can be readily determined by one of ordinary skill in the art.

Without being held to theory, it is believed that by forming a pre-blend as described herein, the nanoparticles become an integral part of the elastomer eventually at molecular dispersion level rather than just blending as fillers. In many respects these nanocomposites resemble the block co-polymer chains with covalently bonded structures and similar dimensions.

In one embodiment, the elastomeric nanocomposites described herein are used in a downhole element, which can be part of an oilfield apparatus. A downhole element is device (or part thereof) used in a downhole operation such as an oilfield operation. Downhole elements may comprise or have coated thereon an elastomeric nanocomposite made by the methods described herein. Exemplary downhole elements include elastomer based packer elements, inflatable seals, submersible pump motor protector bags, blow out preventer elements, sucker rods, sensor protectors, O-rings, T-rings, gaskets, pump shaft seals, tube seals, valve seals and insulators used in electrical components, and the like. The elastomeric nanocomposites are formed into articles such as downhole elements using a mold, for example. In certain embodiments, the elastomeric nanocomposites are coated onto a pre-formed downhole element.

In one embodiment, a method of making a downhole element comprises dispersing a nanoparticle in a liquid form additive to provide a nanoparticle pre-blend, blending the nanoparticle pre-blend with an elastomer to form the nanocomposite, and molding the elastomer into the downhole element.

Because the elastomeric nanocomposites disclosed herein have well-dispersed nanoparticles they provide enhanced performance, including better mechanical properties, barrier properties, chemical and moisture resistance and durability. The resultant nanoparticle reinforced elastomer components therefore can serve more demanding applications such as downhole seals in corrosive, high temperature and high pressure environments.

It should be further appreciated that the elastomeric nanocomposites described herein are readily applied to numerous applications in addition to downhole elements.

The foregoing description is directed to particular embodiments of the present invention for the purpose of illustration and explanation. It will be apparent, however, to one skilled in the art that many modifications and changes to the embodiment set forth above are possible without departing from the scope and the spirit of the invention. It is intended that the following claims be interpreted to embrace all such modifications and changes.

1. A method of making a nanocomposite comprising
dispersing a nanoparticle in an oil, a liquid form additive to provide a nanoparticle pre-blend, and
blending the nanoparticle pre-blend with an elastomer to form the nanocomposite.

2. The method of claim 1, wherein the nanocomposite is a homogeneous nanocomposite.

3. The method of claim 1, wherein the liquid form additive comprises an oil.

4. The method of claim 3, wherein the oil is selected from synthetic and natural mineral oils, naphthenic oils, paraffinic oils, olefin oligomers and low molecular weight polymers, vegetable oils, animal oils, hydrogenated oils, and combinations thereof.

5. The method of claim 1, wherein the liquid form additive comprises a plasticizer.

6. The method of claim 5, wherein the plasticizer is selected from polyester glutarate, trioctyl trimellitate, di(2-ethylhexyl) phthalate; di(butoxy-ethoxy-ethyl) adipate, dibutyl phthalate (DBP), and combinations thereof

7. The method of claim 1, wherein the pre-blend comprises a solvent.

8. The method of claim 7, wherein the solvent is selected from acetone, hexane, ethyl ether, toluene, benzene, chlorobenzene, chloroform, methylene chloride, methyl ethyl ketone, dimethylformamide, tetrahydrofuran, and mixtures thereof.

9. The method of claim 1, wherein the pre-blend is formed by milling, high power probe sonication, or high shear homogenization.

10. The method of claim 7, wherein the solvent is removed prior to blending the nanoparticle pre-blend with an elastomer.

11. The method of claim 1, wherein the nanoparticle comprises single, double, multi-walled nanotubes and nano fibers, nanorods, nanoions, nanocoils, nanofibers, nanoribbons, nanoclay, graphite nanoplatelets, nanoflakes, expanded graphite nanoflakes, expanded nanoplatelets, graphite oxide, thermally exfoliated graphite oxide, graphene sheets, metal oxide nanoparticles, polyhedral oligomeric silsesquioxanes (POSS), nanoparticle minerals, and combinations thereof.

12. The method of claim 11, wherein the nanoparticle is functionalized with long chain hydrocarbons, surfactant molecules with lipophilic ends that dissolve in oils, lipids, non-polar solvents, or a combination thereof, prior to forming the pre-blend.

13. The method of claim 1, wherein blending is by roll milling, shear mixing, or extrusion.

14. The method of claim 7, wherein the elastomer is dissolved in a second solvent prior to blending with the pre-blend, wherein the solvent and the second solvent are the same or different.

15. The method of claim 1, wherein the elastomer is ethylene-propylene-diene monomer (EPDM) rubber, nitrile rubber, nitrile acrylonitrile butadiene rubber (NBR), carboxylated acrylonitrile butadiene rubber (XNBR), hydrogenated acrylonitrile butadiene rubber (HNBR), carboxylated hydrogenated acrylonitrile butadiene rubber (XHNBR), hydrogenated carboxylated acrylonitrile butadiene rubber (HXNBR), ethylene propylene (EPR), tetrafluoroethylene and propylene monomer (FEPM) elastomers, fluoroelastomers (FKM), perfluoroelastomers (FEKM), or a combination thereof.

16. A method of making a downhole element comprising
dispersing a nanoparticle in a liquid form additive to provide a nanoparticle pre-blend,
blending the nanoparticle pre-blend with an elastomer to form the nanocomposite, and
molding the elastomer into the downhole element.

17. The method of claim 16, wherein the liquid form additive comprises an oil, a plasticizer, a solvent, or a combination thereof.

18. The method of claim 17, wherein the nanoparticle is functionalized with long chain hydrocarbons, surfactant molecules with lipophilic ends that dissolve in oils, lipids, non-polar solvents, or a combination thereof, prior to forming the pre-blend.

19. A downhole element comprising a homogeneous nanocomposite, wherein the homogeneous nanocomposite is formed by dispersing a nanoparticle in an oil, a solvent, or both to form a nanoparticle pre-blend, and blending the nanoparticle pre-blend with an elastomer to form the homogeneous nanocomposite.

20. The downhole element of claim 19, wherein the nanoparticle is functionalized with long chain hydrocarbons, surfactant molecules with lipophilic ends that dissolve in oils, lipids, non-polar solvents, or a combination thereof, prior to forming the pre-blend.
